(19) United States
(12) Patent Application Publication
(10) Pub. No.: US 2004/0167970 A1
(43) Pub. Date: Aug. 26, 2004

(54) Method and system for selecting a user interface based on the interface device being used by an operator

(76) Inventor: Darren J. Cepulis, The Woodlands, TX (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/374,011

(22) Filed: Feb. 25, 2003

(51) Int. Cl. G06F 15/167; G06F 15/16

(52) U.S. Cl. 709/213; 709/203

(57) ABSTRACT

A system and method provides the ability to receive an input signal from one of multiple interface devices and, based upon determining from which user interface device the signal was received, select one of a plurality of user interfaces.

### BACKGROUND

Some types of electronic devices may permit a user to perform a configuration process to set or change one or more operating parameters, or perform numerous other actions. An example of such an electronic device may include a computer for which a “set up” routine can be run to permit a user the ability to view and change various parameters such as language, memory operating mode, drivers, etc.

In some instances, the electronic device may be configured via two or more user input/output (“I/O”) or interface devices. A server, for example, may provide the ability to be configured by a user operating a keyboard, mouse and graphics monitor connected to video and input ports on the server, or alternatively by a user operating a terminal (e.g., a VT100) connected to the server via a serial interface. Each interface device may have its own user interface. Examples of user interfaces may include pull-down menus, command line interfaces, and the like. A user interface suitable for one interface device may not be completely suitable for a different type of interface device. For example, a pull-down menu provided on a VGA monitor (which is graphics-oriented) may not display well, or at all, on a VT100 terminal (which is text-oriented). A single, universally compatible interface could be implemented in a “one interface fits all” solution. For example, a command line interface may work on a variety of user interface devices. However, some users may prefer a user interface that is more Windows®, pull-down menu, “point and click” oriented. This latter type of user interface may not work on a text terminal and some users may have and prefer text terminals.

In general, disparate types of user interfaces and user interface devices exist and a need exists to be able to support various types of interfaces and devices. The subject matter described herein may address this issue.

### BRIEF SUMMARY

Various embodiments of systems and methods address the problem described above by providing the ability for a system to receive an input signal from one of multiple interface devices and, based on a determination of which user interface device provided the input signal, to select one of a plurality of user interfaces.

### BRIEF DESCRIPTION OF THE DRAWINGS

For a detailed description of the embodiments of the invention, reference will now be made to the accompanying drawings in which:

FIG. 1 shows a system diagram in accordance with exemplary embodiments of the invention;

FIG. 2 shows a block diagram of a computer coupled to a monitor/keyboard and to a text terminal in accordance with various embodiments of the invention; and

FIG. 3 shows an exemplary method usable in connection with various exemplary embodiments of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct physical connection, or through an indirect connection via other devices and connections. Further, all examples included herein should be construed as being open-ended (i.e., not limiting in any way). As used herein, the term “user interface device” or “interface device” may include one or more physical devices such as a monitor, a keyboard, a mouse, etc. The term “user interface” used without reference to a “device” refers to the format of how the user interacts with the system such as by a command line interface, pull down menus, etc.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment.

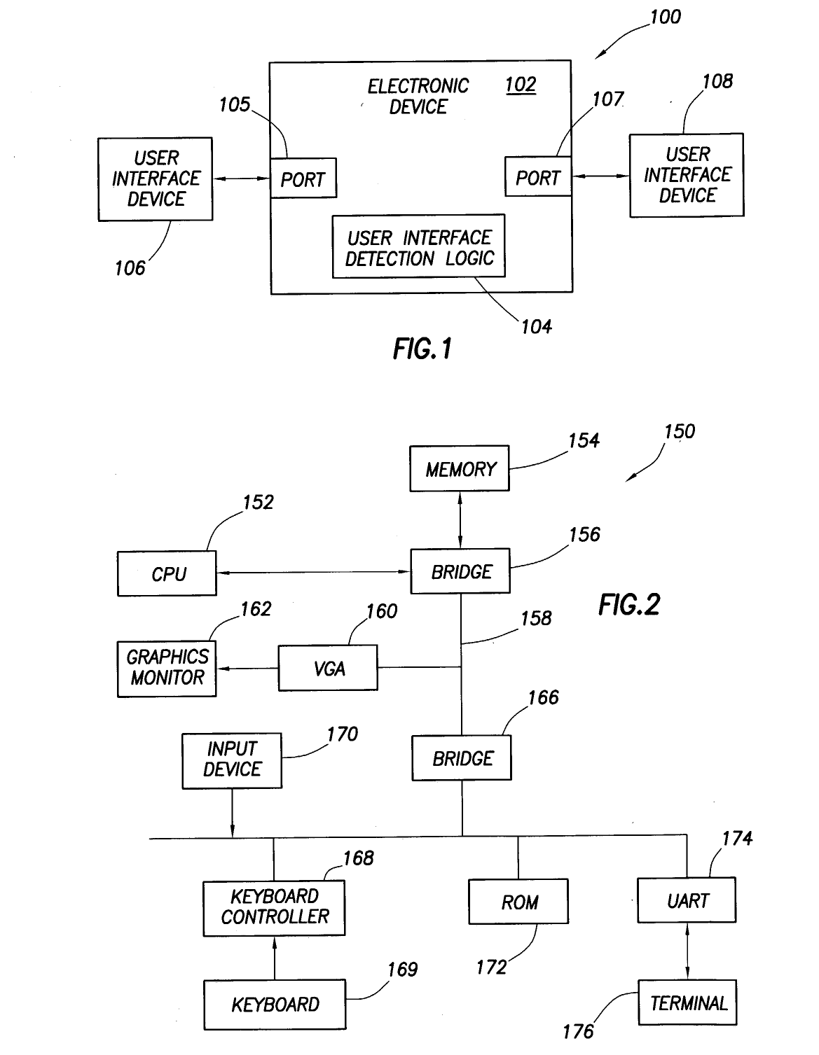

Referring now to FIG. 1, system 100 is shown in accordance with exemplary embodiments of the invention for auto-selection of a user interface. As shown, system 100 may include an electronic device 102 having one or more user interface devices. The electronic device 102 may be coupled to any number of user interface devices. The exemplary embodiment of FIG. 1 includes two ports 105 and 107 and two user interface devices 106 and 108 coupled thereto, although either, or both, of the user interface devices need not be connected to a corresponding ports 105, 107 as desired. That is, either or both of the ports 106 and 108 may be used to interact with the electronic device 102. Any one of a variety of actions may be performed by a user via a user interface device 106, 108. Although not a requirement for this disclosure, the user interface actions relevant to automatically determining an appropriate user interface are those actions that generally relate to system administration. Examples of system administration may include configuration activities, status checks, and the like.

In accordance with exemplary embodiments of the invention, the electronic device 102 may transmit information to, and receive information from, a user interface device 106, 108. Each user interface device 106, 108 may include a display device and an input device (e.g., a keyboard, mouse, etc.). The format of the information transmitted to and/or received from one user interface device may differ from the format of the information relative to another user interface device. In general, the electronic device 102 may implement the same or different user interface for each user interface device 106,108.

Referring still to FIG. 1, the electronic device 102 may include user interface detection logic 104. The user interface detection logic 104 may detect which user interface device 106, 108 a user is currently using to perform a user interface action. For purposes of this disclosure, the user interface device 106, 108 that the user is currently using to interact with the electronic device is referred to as the “active” user interface. Once the active user interface device 106 or 108 is determined by the user interface detection logic 104, the electronic device 102 invokes a user interface appropriate for the active user interface device.

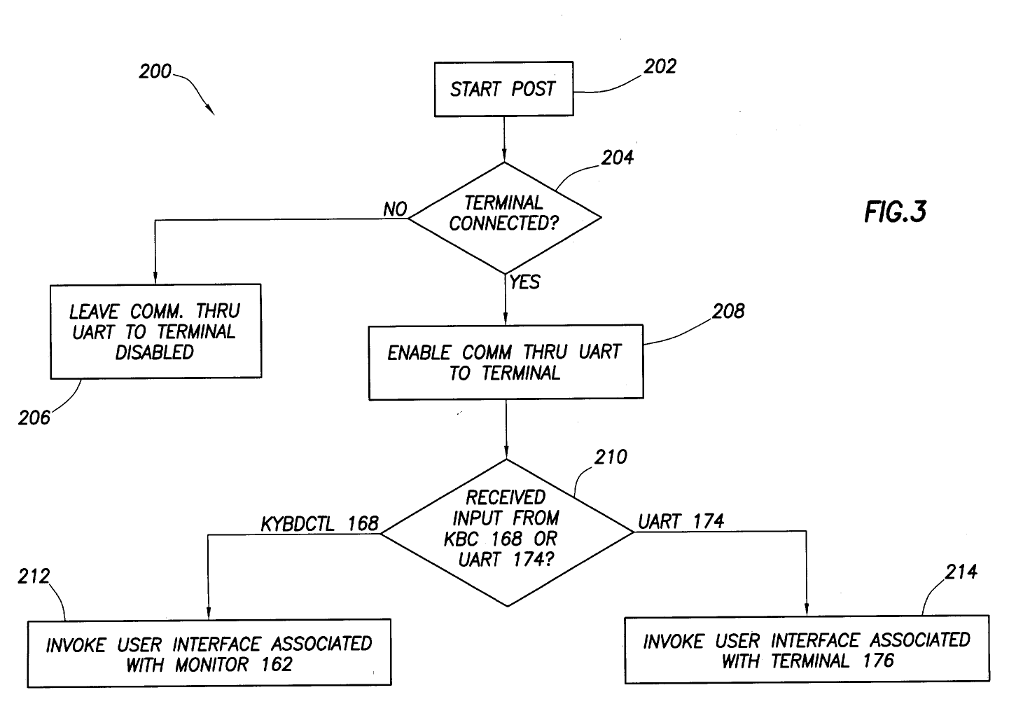

Referring now to FIG. 2, system 150 may include a central processing unit (“CPU”) 152, memory 154, bridge devices 156,166, a video graphics adapter (“VGA”) 160, and a graphics monitor 162. The system 150 may also include a keyboard controller 168, keyboard 169, input device 170 (e.g., a mouse), read only memory (“ROM”) 172, universal asynchronous receiver transmitter (“UART”) 174, and terminal 176. As shown, the CPU 152 and memory 154 (which may comprise volatile memory) may couple to bridge 156. Bridge 156 may couple to another bridge 166 by way of a bus 158. Bus 158 may be implemented in accordance with any suitable standard or protocol such as, without limitation, Peripheral Component Interconnect (“PCI”). One or more other devices may couple to bridge 166. In the exemplary embodiment of FIG. 2, such devices may include the keyboard controller 168, read only memory (“ROM”) 172, and UART 174. The keyboard 169 may provide input to the system via the keyboard controller 168 and the terminal 176 may interact with the system via UART 174, which may provide a serial communication link between the system 150 and terminal 176. In general, the system 150 may comprise a server computer or other type of electronic system.

In accordance with various embodiments as in FIG. 2, two user interface devices may be coupled to the system 150. One user interface device may comprise graphics monitor 162 coupled to the system 150 via VGA 160. This user interface device may also include keyboard 169 and input device 170. Of course, any of a variety of other input/output devices may be included as desired. The other user interface device may include terminal 176.

The ROM 172 may include software (also known as “firmware”) which may be copied to memory 154 and executed therefrom by CPU 152. At least some, or all, of the functionality described herein may be performed by the CPU 152 executing such software. The ROM 172 also may include basic input/output system (“BIOS”) firmware. The software, which may be used to implement the functionality described herein may be part of, or separate from, the BIOS. The user interface auto-selection capability described herein may be implemented in conjunction with running ROM-based utilities. An exemplary process performed with the assistance of the software is shown in FIG. 3.

Referring now to FIG. 3, in conjunction with FIG. 2, a method 200 may include blocks 202-214. The process 200 may be performed during a power on self-test (“POST”) procedure in which various aspects (e.g., memory 154) may be tested. Entry into the POST procedure is depicted by block 202. During or after POST, control may pass to decision block 204 in which the CPU 152 determines whether terminal 176 is coupled to the system, which may or may not be connected. In some embodiments, the system 150 initializes without the capability to communicate through the UART 174 to the terminal (which, in fact, may be absent altogether). Accordingly, decision block 204 may be included to detect the presence or absence of the terminal 176 as described below. If the terminal 176 is absent the system's ability to communicate through the UART 174 remains disabled (block 206). If, however, it is determined that the terminal 176 is present, then the system's ability to communicate through the UART 174 to the terminal 176 may be enabled (block 208). Enabling this communication path may be performed in any suitable manner, such as by setting a suitable flag.

Determining whether the terminal 176 is present may be performed in a variety of ways. Without limitation, one exemplary method is to transmit a predetermined bit sequence and wait for a response from the terminal, if present. For example, if the terminal comprises a VT100 terminal, a known escape sequence may be transmitted by the UART 174. If present, the terminal 176 will receive the escape sequence and return status information. If such status information is received by the UART 174, then the CPU 152 may determine that the terminal 176 is present. If no status information is received within a predetermined period of time, the CPU 152 may determine that the terminal 176 is absent.

In some embodiments, the system 150 may initialize with the ability to communicate through the UART 174 to the terminal already enabled. In this case, the actions depicted in blocks 204, 206 and 208 may be omitted.

Referring still to FIGS. 2 and 3, control may pass to decision block 210. In general, one or more user interface devices may be coupled to the 150. That is, either, or both, of the terminal 176 and monitor 162/keyboard 169/mouse 170 may be coupled to the system 150. Decision block 210 may be included to permit the CPU 152 to determine which of the user interface devices a user of the system is actually using to interact with the system 150. Although both user interface devices may be coupled to system 150, the user may desire to use the monitor/keyboard/mouse interface device. Alternatively, the user instead may desire to use the terminal 176. As described in block 210, the CPU 152 may determine which interface device is being used.

Any one of a variety of techniques may be used to implement decision block 210. The following represents one suitable implementation. During POST, the system 150 may provide a timed prompt for the user to press a predetermined key or key combination to enter a “setup” mode. The setup mode, which may be implemented with routines from ROM 172, may permit the user to configure a variety of system parameters. The predetermined key may include the “F9” key. If the user desires to enter the setup mode, the user may press the F9 key at the appropriate time as indicated by messages provided on monitor 162 and terminal 176. The CPU 152 then may determine the source of the F9 key press. That is, the CPU 152 may determine whether the user pressed the F9 key on the keyboard 169 or on a keyboard (not specifically shown) associated with the terminal 176.

If the source of the F9 key press is the keyboard 169, control passes in FIG. 3 to block 212 in which a user interface appropriate for monitor 162 may be invoked. This user interface may include, without limitation, a graphics window with pull-down menus and the like. If, however, the source of the F9 key press is the terminal 176, control passes to block 214 in which a user interface appropriate for the terminal 176 may be invoked. This interface may include, without limitation, a command line interface (“CLI”).

The above discussion is meant to be illustrative of the principles and various embodiments of the present invention. Numerous variations and modifications will become apparent to those skilled in the art once the above disclosure is fully appreciated. For example, other keys and services besides “F9” and “setup” may be monitored to determine the type of user interface to invoke. It is intended that the following claims be interpreted to embrace all such variations and modifications.

What is claimed is:

1. A method usable in a system being controllable by a text terminal and a graphics display, comprising:
receiving an input signal from said text terminal or a keyboard associated with said graphics display;
determining from which of said text terminal or keyboard said input signal was received; and
selecting a command line interface or a graphics interface based on which of said text terminal or keyboard said signal was received.

2. The method of claim 1 further including determining whether the text terminal is coupled to said system and, if coupled, enabling communication between the system and said interface device.

3. The method of claim 1 wherein said graphics interface includes a pull-down menu.

4. The method of claim 1 wherein said selecting includes selecting the command line interface if said signal is received from said text terminal or selecting a pull-down menu interface if said signal is received from the keyboard associated with the graphics display.

5. The method of claim 1 wherein said signal comprises a signal indicative of a predetermined key.

6. A computer system, comprising:
a CPU;
memory coupled to said CPU and containing software executed by said CPU;
a graphics monitor and associated input device coupled to said bridge; and
a receiver/transmitter coupled to said bridge and providing a communication link to a text terminal;
wherein said CPU determines whether a user is using said input device or said text terminal to access said computer system and, among a plurality of user interfaces, invokes a user interface associated with whichever of the graphics monitor or text terminal that the CPU determines is being used by the user, a user interface associated with the graphics monitor is different from a user interface associated with the text terminal.

7. The computer system of claim 6 wherein the CPU determines whether the input device or text terminal is being used by the user by receiving an input signal and determining from which of the input device or text terminal the signal was received.

8. The computer system of claim 7 wherein the signal is indicative of an F9 key being pressed on the input device or text terminal.

9. The computer system of claim 6 wherein said CPU determines if the text terminal is coupled to the receiver/transmitter and, if the text terminal is coupled thereto, said CPU enables communication between said computer system and said text terminal.

10. The computer system of claim 6 wherein the user interface is invoked when a user enters a set up mode.

11. The computer system of claim 6 wherein the user interface comprises a command line interface if the text terminal is being used or a graphics interface if the graphics monitor is being used.

12. A storage medium on which software is stored, said software being executable by a CPU and causing said CPU to perform a plurality of actions, comprising:
receiving an input signal associated with a text terminal or a graphics monitor;
determining from which of said text terminal or graphics monitor said input signal was received; and
selecting a user command line interface or a graphics interface based on determining from which of the text terminal or graphics monitor said signal was received.

13. The storage medium of claim 12, said actions also comprising determining whether the text terminal is coupled to a system containing the storage medium and, if coupled, enabling communication between the system and said text terminal.

14. An electronic system, comprising:
a text terminal having a command line interface associated therewith;
a graphics display having a graphics interface associated therewith; and
a means for detecting which of said text terminal or graphics display a user is accessing and for causing the interface associated with the detected terminal or display to be invoked.
